(19) United States
(12) Patent Application Publication
(10) Pub. No.: US 2006/0166768 A1
(43) Pub. Date: Jul. 27, 2006

(54) Method and apparatus for determining a slippage value that represents a slippage condition between two rotating components

(75) Inventor: Michael Reuschel, Ottersweier (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/318,091

(22) Filed: Dec. 23, 2005

(30) Foreign Application Priority Data
Dec. 24, 2004 (DE) 10 2004 062 610.3

(51) Int. Cl. F16H 55/56

(52) U.S. Cl. 474/8

(57) ABSTRACT

A method for determining a slippage value that shows a slippage condition between two components that transmit torque through frictional engagement, in particular such components that are contained in the power train of a motor vehicle. The effect on the difference in rotational speed between the components of a change in an excitation that influences the slippage condition is analyzed, and the slippage value is determined therefrom. A non-uniformity of rotation of at least one of the components is utilized as the excitation.

### BACKGROUND OF THE INVENTION

1. Field of the Invention

The present invention relates to a method for determining a slippage value that represents a slippage condition between two rotating components that transmit torque through frictional engagement, in particular components contained in the power train of a motor vehicle. The invention also relates to apparatus for carrying out such a method.

2. Description of the Related Art

For reasons of convenience, fuel consumption, and environmental reasons, automated power trains are increasingly being used in motor vehicles. Such power trains include, for example, a belt-driven conical-pulley transmission with continuously variable transmission ratio. To ensure continuously reliable operation of such a transmission, suitable contact pressure between the endless torque-transmitting means and the conical disks is crucial. In that context, suitable means first that the contact ensures that the endless torque-transmission means does not slip, and second, that the contact pressure is not unnecessarily high, so that it does not produce any unacceptable loads on parts or detract from the efficiency as a result of the high hydraulic pressure that must be provided. To control or regulate the contact pressure efficiently, exact knowledge of the slippage condition between the conical disks of the belt-driven conical-pulley transmission and the endless torque-transmitting means is necessary. Direct measurement of that slippage is complicated and expensive, since, in addition to the rotational speeds of the pairs of conical disks and the speed of the endless torque-transmitting means, it is also necessary to know the exact effective radii at which the frictional engagement between the endless torque-transmitting means and the conical surfaces of the pairs of conical disks occurs.

An object of the invention is to provide an easily performed method for determining a slippage value that shows a slippage condition. Another object of the invention is to provide apparatus for determining a slippage value that reflects a slippage condition.

### SUMMARY OF THE INVENTION

The method aspect of the object of the invention is achieved with a method for determining a slippage value that represents a slippage condition between two components that transmit torque through frictional engagement, in particular such components contained in the power train of a motor vehicle. The effect on the motion of the components of a change in an excitation that influences the slippage condition is analyzed, and the slippage value is determined therefrom. A non-uniformity of rotation of at least one of the components is utilized as the excitation.

Since non-uniformities of rotation are present in many types of propulsion sources, in particular piston-type internal combustion engines, and their magnitude is governed by the operating mode of the combustion engine or is known by measuring, the method in accordance with the invention does not require a source of excitation of its own. For example, a pressure modulator to modulate a control pressure that determines the contact force between, for example, a particular conical disk set and an endless torque-transmitting means is not required.

Preferably, the slippage value is determined by a method in which the amplitude of the effect is evaluated at a certain frequency.

In an advantageous embodiment of the method in accordance with the invention, the slippage value is determined by means of the lock-in principle, which will be explained later. In principle, however, other methods are also conceivable for the evaluation, such as a cross-correlation method, a Fourier transformation, or special filters.

Advantageously, at least one bandpass filter is used in the analysis of the differences in rotational speed.

As explained earlier, the method in accordance with the invention can be used especially advantageously when the non-uniformity of rotation of a piston-type internal combustion engine that drives one of the two components is used as the excitation.

Preferably, the first-order excitation is used.

It is also useful to perform the determination of the slippage value only in at least one predetermined rotational speed range.

The method can advantageously be further refined so that the amplitude of a rotational vibration caused by the excitation is detected, and a correlation with the determined slippage value is performed.

Apparatus for determining the slippage condition between two components that transmit torque through frictional engagement, in particular such components contained in the power train of a motor vehicle, with which the object of the invention is achieved, includes apparatus for determining an excitation that influences the slippage condition. Also included are apparatus for determining rotational speeds of the components, and apparatus for analyzing the difference in rotational speed and for determining the slippage value, which analysis and determination unit works in accordance with one of the above-mentioned methods.

The invention can be employed anywhere where a slippage condition exists between two components that transmit torque through frictional engagement, in particular rotating components. The slippage advantageously has a predetermined value, possibly a value that is a function of operating parameters of the transmission of torque. The slippage condition can be present between a rotating component and one with linear or circulation movement, or between rotating components that are in direct frictional engagement or indirect frictional engagement, with one or more components interposed.

### BRIEF DESCRIPTION OF THE DRAWINGS

The structure, operation, and advantages of the present invention will become further apparent upon consideration of the following description, taken in conjunction with the accompanying drawings in which:

FIG. 1 is a schematic diagram of a part of a power train of a motor vehicle having a belt-driven conical-pulley transmission and corresponding controls;

FIG. 2 is a graph showing excitation by non-uniformity of rotation; and

FIGS. 3a-3e show graphs to explain the lock-in principle.

### DESCRIPTION OF THE PREFERRED EMBODIMENTS

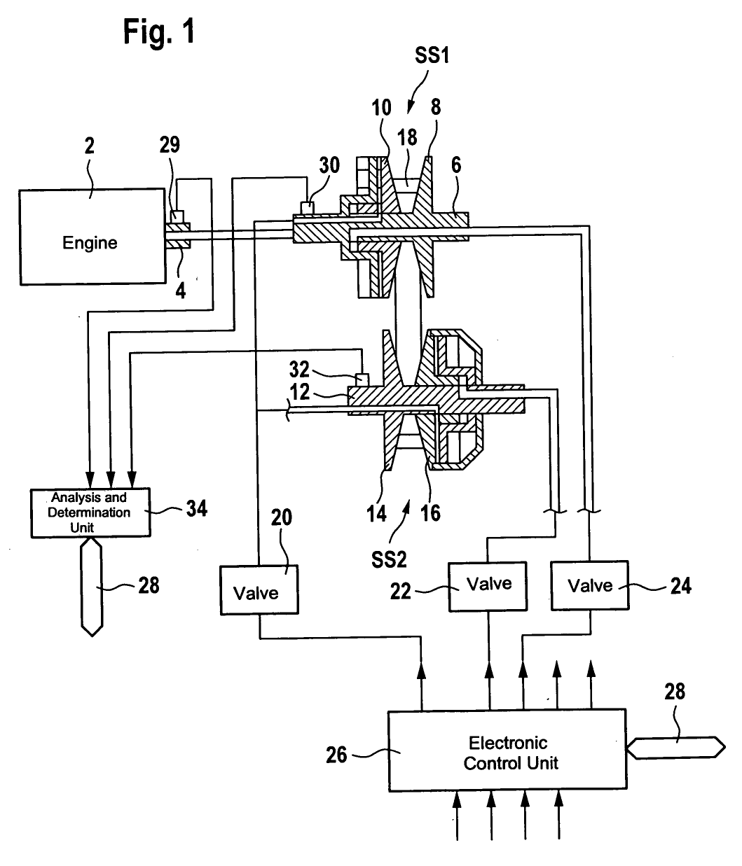

FIG. 1 shows a section of a power train of a motor vehicle with the associated control units. An input shaft 6 is rigidly connected to one conical disk 8 of an input side conical disk set SS1 and is driven by an internal combustion engine 2 by an engine shaft 4, an intermediate arrangement, preferably automatic clutch (not shown), and a reversible-direction transmission. Another conical disk 10 is positioned on input shaft 6 so that it is rotationally fixed and axially movable. Positioned between conical disk 10 and a supporting component that is rigidly connected to input shaft 6 are pressure chambers, by which, when they are pressurized, it is possible to change the force with which conical disk 10 can be pressed in the direction of conical disk 8.

In a similar manner, an output side disk set SS2 has a conical disk 14 that is rigidly connected to a take-off or output shaft 12, and an axially movable conical disk 16 that can be forced in the direction of conical disk 14 by pressurizing associated pressure chambers. Between the two conical disk sets SS1 and SS2 an endless torque-transmitting means 18 circulates, for example a link chain.

The contact force with which endless torque-transmitting means 18 contacts the conical surfaces of the conical disks in a frictional connection is controlled by means of hydraulic valves 20, 22, and 24, where hydraulic valve 20, for example, determines in a known way a basic contact pressure that depends on the torque acting on input shaft 6, and the adjustment of the transmission ratio is accomplished with hydraulic valves 22 and 24.

The control of valves 20, 22, and 24 is accomplished by an electronic control unit 26, at the inputs of which there are signals from sensors that contain essential information for controlling the valves, which are converted to control signals for the valves in accordance with algorithms stored in control unit 26. Other outputs of control unit 26 can trigger an automatic clutch, for example. The hydraulic valve 20 can be controlled independently by a mechanical torque sensor, without connection to the control unit 26. Hydraulic valves 22 and 24 for shifting the transmission ratio are not both essential. Advantageously, control unit 26 communicates through a bus conduit 28 with other control units or electronic units of the motor vehicle.

Since the construction and function of the arrangement described so far are known, further details will not be described.

Suitable contact pressure between endless torque-transmitting means 18 and conical disk sets SS1 and SS2 is crucial for prolonged reliable operation of the belt-driven conical-pulley transmission. That contact pressure must be such that the endless torque-transmitting means does not slip, i.e., it does not slip more than permitted, and on the other hand it must not be unnecessarily high, so that the components are lightly loaded and the transmission operates with good efficiency.

The determination of a slippage value in accordance with the invention will now be explained:

The rotational speed of the internal combustion engine 2 or of its engine shaft 4 is detected by a rotational speed sensor 29. The rotational speed of the input shaft 6 is detected by a rotational speed sensor 30. The rotational speed of the output shaft 12 is detected by a rotational speed sensor 32.

Rotational speed sensors 29, 30, and 32 are connected to an analysis and determination unit 34, which receives data from the bus 28 that provide the rotational speed and, advantageously, also the load at which the internal combustion engine 2 is running, so that the analysis and determination unit 34 contains information about the non-uniformity of rotation with which internal combustion engine 2 is driving input shaft 6. Of course, the non-uniformity of rotation can also be obtained directly by analyzing the signals supplied by rotational speed sensor 29, for example by evaluating the maximum and minimum rotational speeds of internal combustion engine 2.

The non-uniformities of rotation at the crankshaft of an internal combustion engine represent an excitation in the frequency range between 15 and 100 Hz, for example, depending on the speed and the order. That system-inherent excitation can be used to determine the slippage condition. Since the excitation speed changes with the rotational speed, it is advisable to take into account only special frequencies, and to perform an evaluation of the slippage condition only at those special frequencies. For example, if a four-cylinder engine is running in a speed range between 1500 and 2000 rpm, an evaluation can be made for an excitation frequency between 25 and 35 Hz. As a filter, one can use a band-pass filter that passes frequencies that are between those frequencies. It is advantageous to determine the excitation amplitude itself, which is stored in a characteristic map, for example, as a function of the rotational speed and the load on the internal combustion engine, or is derived from the signal of sensor 30. The excitation amplitude has an influence on the slippage condition of the belt-driven transmission.

For excitation it is possible to use all non-uniformities of rotation that are excited in the power train, for example, in addition to the non-uniformities of the internal combustion engine, rotational non-uniformities that arise from a driven pump.

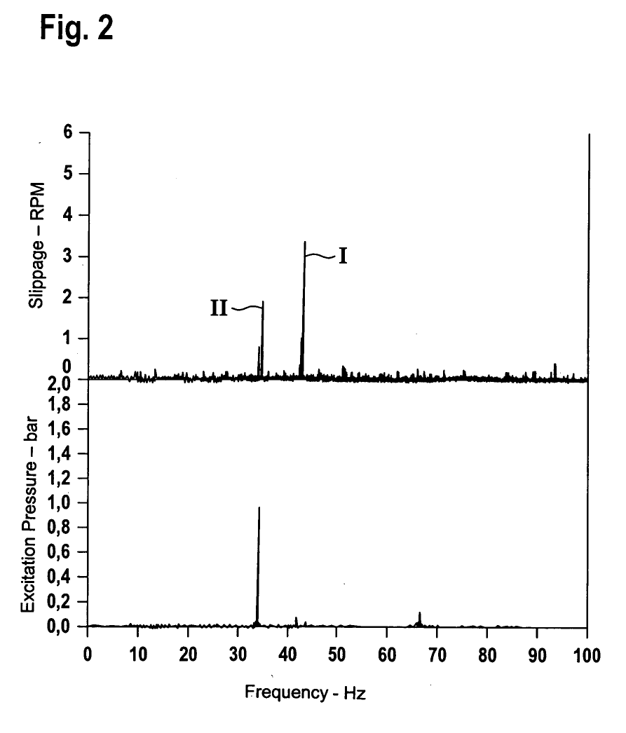

The upper plot of FIG. 2 shows an FFT (fast Fourier transform) analysis of the slippage of the belt-driven transmission, whose input shaft is rotating at a constant average speed. The slippage information is obtained here in accordance with the following method:

First, the variator transmission ratio iᵥₐᵣ is obtained from the quotient of the difference in input or output speeds ω_{SS1} and ω_{SS2}. The applicable equation is: iᵥₐᵣ=ω_{SS1}/ω_{SS2}.

That value is then low-pass filtered: the result is i_{var,TP}.

That low-pass filtered value is then used to calculate the rotational speed difference between the input and output speeds:
n_{diff}=ωSS1−i_{var,TP}*ω_{SS2}.

That rotational speed difference is processed with a bandpass filter, where the limiting frequencies can lie between 25 and 45 Hz, for example.

To calculate the slippage, the result of that bandpass filtering of the rotational speed difference is then processed by means of a Fourier transform. The amplitudes of that transform correspond to the slippage, and are shown in the upper half of FIG. 2.

The peak designated by I indicates the slippage value induced by the rotational non-uniformity of the internal combustion engine. The peak designated by II indicates the slippage value that is excited by an active change in the contact pressure with a frequency of about 35 Hz, as shown in the lower part of FIG. 2. The abscissa shows the frequency in Hz in each case. The ordinate of the lower half is the excitation pressure in bar. The ordinate of the upper half is the slippage in rpm.

It is clearly evident from FIG. 2 that the slippage produced by the rotational non-uniformity (I) is greater than the slippage induced by the active pressure oscillation. Accordingly, the detection of the slippage induced by a rotational non-uniformity is very well suited for determining slippage or for determining a value that represents the slippage.

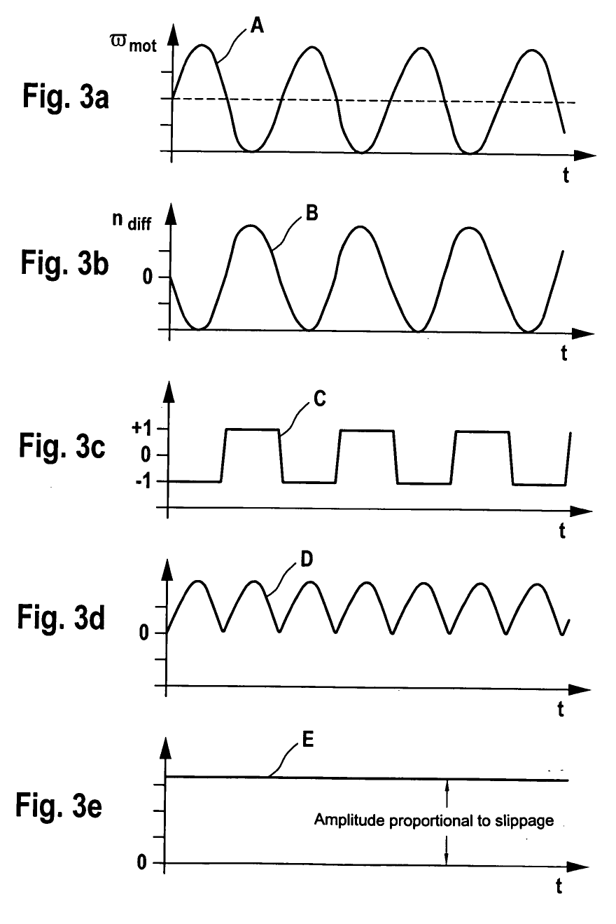

The determination of slippage using the excitation resulting from a rotational non-uniformity and employing the so-called lock-in method will be explained below as an example on the basis of FIG. 3.

Curve A in FIG. 3a shows the rotational speed w of the non-uniformly rotating shaft 4 of the internal combustion engine 2 over time, where the frequency of the change in rotational speed is for example about 30 Hz.

Curve B of FIG. 3b shows the difference in rotational speed n_{diff}=ω_{SS1}−i_{var,TP}*ω_{SS2}, where ω_{SS1} and ω_{SS2} are measured directly by the rotational speed sensors 30 and 32, and i_{var,TP} is the effective low-pass filtered transmission ratio of the belt-driven transmission. The transmission ratio i_{var,TP} can be determined from the ratio of ω_{SS1} to ω_{SS2} by appropriate low-pass filtering, for example.

Curve C in FIG. 3c is derived from curve A; it has the value +1 when the value of Plot A is above the dashed mean plotted in part a), and the value −1 when it is below the mean.

Curve D in FIG. 3d shows curve B multiplied by curve C; that is, it gives the absolute value by which curve B, i.e., the rotational speed difference n_{diff}, fluctuates around its mean.

Curve E in FIG. 3e gives the average value of curve D, which is determined by any suitable filtering or averaging method. The magnitude of curve E, i.e., its distance from the abscissa, corresponds to the slippage of the belt-driven conical-pulley transmission. With the help of that slippage value, it is possible for example to control or regulate the contact force between the conical disk pairs and the torque-transmitting means so that it corresponds to an optimum that is a function of the particular operating conditions.

The described lock-in method constitutes a computing-time-favorable method for calculating the slippage value of a belt-driven transmission. Alternatively, it is also possible to employ any analytical methods that calculate the spectrum of the rotational speed difference n_{diff}. In concrete terms, a fast Fourier transformation can also be employed to calculate the slippage value (see FIG. 2).

The described method has the advantage that an active excitation, such as that from active pressure modulation, for example, is not necessary, and it is therefore also usable with mechanical-hydraulic contact pressure systems to determine the actual contact pressure reliability. One known system for such contact pressure systems is a torque sensor, such as those installed in continuously variable transmissions.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for determining a slippage value that represents a slippage condition between two components that transmit torque through frictional engagement, such as two components contained in the power train of a motor vehicle, said method comprising the steps of: analyzing an effect on the motion of the components of a change in an excitation that influences a slippage condition and determining a slippage value; and detecting a non-uniformity of rotation of at least one of the components for use as the excitation.

2. A method in accordance with claim 1, including the step of determining the slippage value by a method in which the amplitude of the excitation is evaluated at a predetermined excitation frequency.

3. A method in accordance with claim 1, including the step of determining the slippage value by means of the lock-in principle.

4. A method in accordance with claim 1, wherein at least one bandpass filter is used in the analysis of the motions.

5. A method in accordance with claim 1, including the step of utilizing as the excitation a rotational non-uniformity of a piston-type internal combustion engine that drives one of the two components.

6. A method in accordance with claim 5, wherein a first-order excitation is used.

7. A method in accordance with claim 1, wherein the determination of the slippage takes place only within at least one predetermined rotational speed range.

8. A method in accordance with claim 1, including the steps of: detecting the amplitude of a rotational vibration caused by the excitation; and performing a correlation with the determined slippage value.

9. Apparatus for determining the slippage condition between two components that transmit torque through frictional engagement, such as components contained in the power train of a motor vehicle, said apparatus comprising:
means for determining an excitation that influences the a slippage condition between the components;
means for determining rotational speeds of the components; and
means for analyzing a difference in rotational speeds and for determining a slippage value, which analysis and determination means operates in accordance with the method claimed in claim 1.
